(19) United States
(12) Patent Application Publication
(10) Pub. No.: US 2003/0020263 A1
(43) Pub. Date: Jan. 30, 2003

(54) Unitary composite air bag cover and method of making same

(75) Inventor: Darius J. Preisler, Macomb, MI (US)

Correspondence Address: BROOKS & KUSHMAN, 1000 TOWN CENTER 22ND FL, SOUTHFIELD, MI, 48075

(73) Assignee: Patent Holding Company, Fraser, MI

(21) Appl. No.: 10/252,177

(22) Filed: Sep. 23, 2002

Related U.S. Application Data
(62) Division of application No. 08/908,773, filed on Aug. 8, 1997.

(51) Int. Cl. B60R 21/20

(52) U.S. Cl. 280/728.3

(57) ABSTRACT

A unitary composite air bag cover including a one-piece thermoplastic elastomeric body and a one-piece outer layer molded from a thermoplastic material compatible with the thermoplastic elastomer of the body is provided so that a bottom contact surface of the outer layer bonds with a front contact surface of the front panel by diffusion between the contact surfaces thereof. In a method of the present invention, the resulting air bag cover is cooled beneath the softening point of both plastics so that a molecular concentration gradient is formed at an interface between the first and second plastics to bond the first and second plastics by diffusion within a mold cavity of a mold separate from the mold cavity of another mold which is utilized to injection-mold either the elastomeric body or the outer layer.

### TECHNICAL FIELD

This invention relates to unitary composite air bag covers and methods of making same, and, in particular, to unitary composite plastic air bag covers and methods of making same.

### BACKGROUND ART

Supplemental occupant restraint systems for motor vehicles (i.e., air bags) typically require covers which allow an air bag to exit the air bag cover when deployed. One type of air bag cover includes a front panel which has a predetermined tear seam design formed therein to allow the air bag to exit the air bag cover when deployed. Another type of air bag cover (i.e., on the passenger side) has a predetermined tear seam design formed in one of its side panels to also allow the air bag to exit the air bag cover when deployed.

Not only must the air bag cover perform the utilitarian function of breaking apart along its predetermined tear seam design, but it should also match the vehicle interior decor and trim materials such as the instrument panel, seats, door panels, steering wheel and posts.

Also, not only must the air bag cover allow the air bag to exit the air bag cover when deployed, but also the air bag cover must stay together to the extent that it does not break apart so as to present projectile(s) which may injure an occupant of the motor vehicle.

Also while it is desirable that the air bag cover be relatively stiff so as to be properly secured to the rest of the air bag system and also possibly during horn actuation, it is also desirable that the surface of the air bag which faces the occupants of a vehicle be soft and smooth to the touch.

In the manufacture of air bag covers, it is also important in the design of any air bag cover to take into account machine down-time and also to utilize the smallest injection molding machines possible.

Finally, most air bag covers must be painted in order to match or conform the air bag cover to the styling and aesthetic requirements of the associated interior trim products. However, painting such air bag covers may have its own pitfalls, especially where the paint used may have difficulty adhering to the plastic used in the air bag cover. Also, such painting requires a manufacturing step with all the attendant costs and timing problems associated therewith. Finally, if too much paint is used, deployment of the air bag may be effected.

The U.S. Pat. No. 5,335,935, to Proos et al., discloses an air bag cover/molded article with an integral cover layer of leather or with a flexible resilient cover sheet such as polyvinyl chloride sheeting

The U.S. Pat. No. 5,096,221, to Combs et al., discloses an air bag cover with plural substrates such as vinyl, soft foam backing, and first and second substrates.

### SUMMARY OF THE INVENTION

It is an object of the present invention to provide a unitary composite air bag cover including a one-piece thermoplastic elastomeric body injection molded in a first mold and a one-piece outer layer injection molded in a second mold from a thermoplastic material compatible with the thermoplastic elastomer of the body so that a bottom contact surface of the outer layer bonds with a front contact surface of the front panel by diffusion between the contact surfaces thereof.

Another object of the present invention is to provide a unitary composite air bag cover which has a soft outer shell to increase customer satisfaction yet also have a stiff inner material to support a door of the air bag cover during deployment.

Yet still another object of the present invention is to provide a method for making a unitary composite air bag cover for an inflatable air bag system wherein independent molding of the separate components of the air bag cover is done to relieve machine down-time and also to permit the utilization of smaller injection molding machines.

It is yet another object of the present invention to provide a unitary composite air bag cover and a method of making same wherein a one-piece outer layer of the composite air bag cover does not need paint.

In carrying out the above objects and other objects of the present invention, a unitary composite air bag cover is provided. The air bag cover includes a one-piece, thermoplastic elastomeric body injection molded in a first mold with a predetermined tear seam design formed therein. The air bag cover includes a front panel having front and back contact surfaces and side panels extending from the back contact surface of the front panel and adapted to secure the air bag cover over an inflatable air bag system. The air bag cover also includes a one-piece outer layer injection molded in a second mold from a thermoplastic material compatible with the thermoplastic elastomer of the body so that a bottom contact surface of the outer layer bonds with the front contact surface of the front panel by diffusion between the contact surfaces thereof in one of the first and second molds to prevent the body from separating from the outer layer during use of the air bag cover.

Further in carrying out the above objects and other objects of the present invention, a unitary composite air bag cover is provided which consists essentially of a thermoplastic elastomeric body injection molded in a first mold with a predetermined tear seam design formed therein and having an outer contact surface, and a thermoplastic outer layer injection molded in a second mold and having an inner contact surface bonded to the outer contact surface of the body. The outer layer is bonded with the body by diffusion between the contact surfaces thereof in one of the first and second molds to form the air bag cover and to prevent the outer layer from separating from the body during use of the air bag cover.

Still further in carrying out the above objects and other objects of the present invention, a unitary composite air bag cover is provided which consists essentially of a relatively rigid thermoplastic elastomeric body injection molded in a first mold with a predetermined tear seam design formed therein and having an outer contact surface, and a relatively soft thermoplastic outer layer injection molded in a second mold and having an inner contact surface bonded to the outer contact surface of the body. The outer layer is bonded with the plastic body by diffusion in one of the first and second molds to form the air bag cover and to prevent the outer layer from separating from the bonded body during use of the air bag cover.

Also in carrying out the above objects and other objects of the present invention, a method is provided for making a unitary composite air bag cover for an inflatable air bag system. The method includes the steps of injecting a first molten plastic into a mold cavity of a first mold having a shape defining a first part of the air bag cover, permitting the resulting first part to cool to a temperature beneath the softening point of the first plastic, removing the first part from the first mold, and inserting the first part into a mold cavity of a second mold having a shape defining the entire air bag cover. The method also includes the steps of injecting a second molten plastic into the mold cavity of the second mold at a temperature and pressure sufficient to melt a surface layer of the first part, and permitting the resulting air bag cover to cool to a temperature beneath the softening point of both plastics so that a molecular concentration gradient is formed at an interface between the first and second plastics to bond the first and second plastics by diffusion. Finally, the method includes the step of removing the completed air bag cover from the second mold.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is an environmental view showing two types of air bag covers constructed in accordance with the present invention;

FIG. 2 is a front elevational view of one type of air bag cover adapted to be mounted at an end of a steering wheel post;

FIG. 3 is a sectional view of the air bag cover of FIG. 2 taken along lines 3-3 in FIG. 2;

FIG. 4 is a sectional view of the air bag cover of FIG. 2 taken along lines 4-4 in FIG. 2;

FIG. 5 is a front elevational view of the second type of air bag cover adapted to be secured within an opening formed in a dashboard or instrument panel on the passenger side;

FIG. 6 is a sectional view of the air bag cover of FIG. 5 taken along lines 6-6 of FIG. 5;

FIG. 7 is a sectional view of the air bag cover of FIG. 5 taken along lines 7-7 of FIG. 5;

FIG. 8 is a schematic view of a pair of conventional injection molding systems which may be utilized to make the air bag covers of the present invention; and

FIG. 9 is a block diagram flow chart illustrating the various method steps taken to practice the method of the present invention in order to make the air bag covers.

### BEST MODE FOR CARRYING OUT THE INVENTION

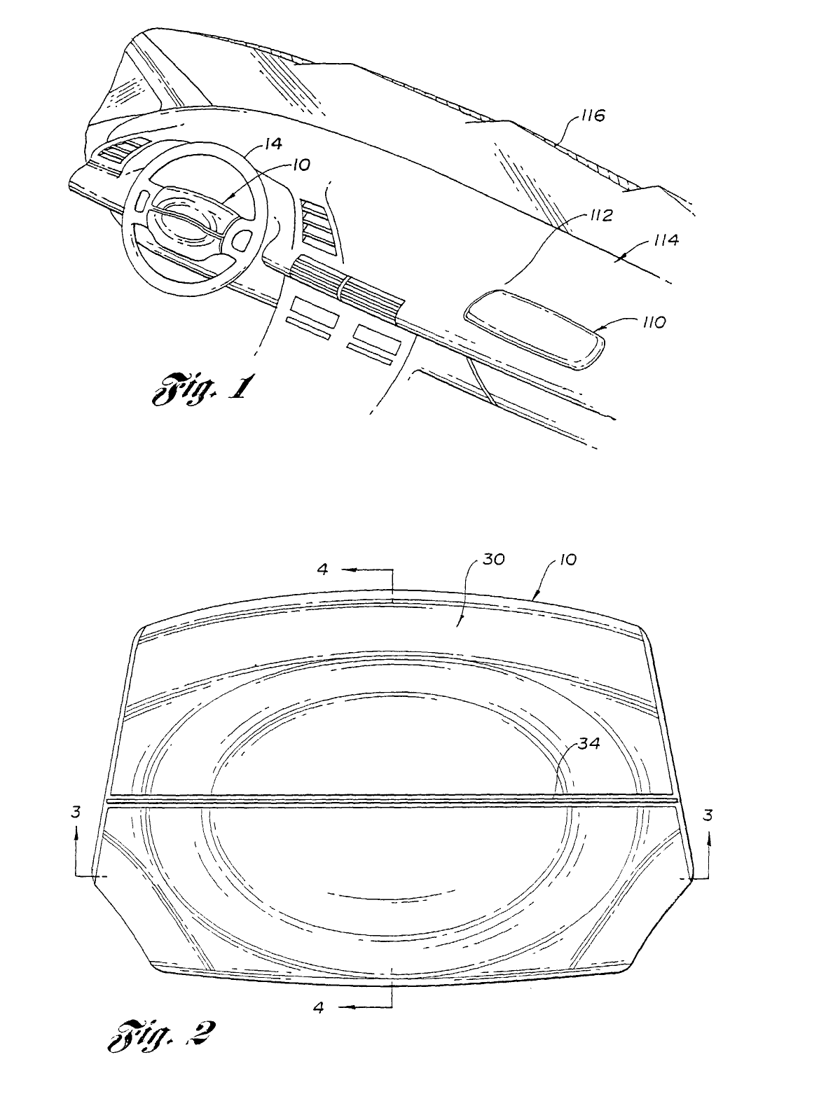

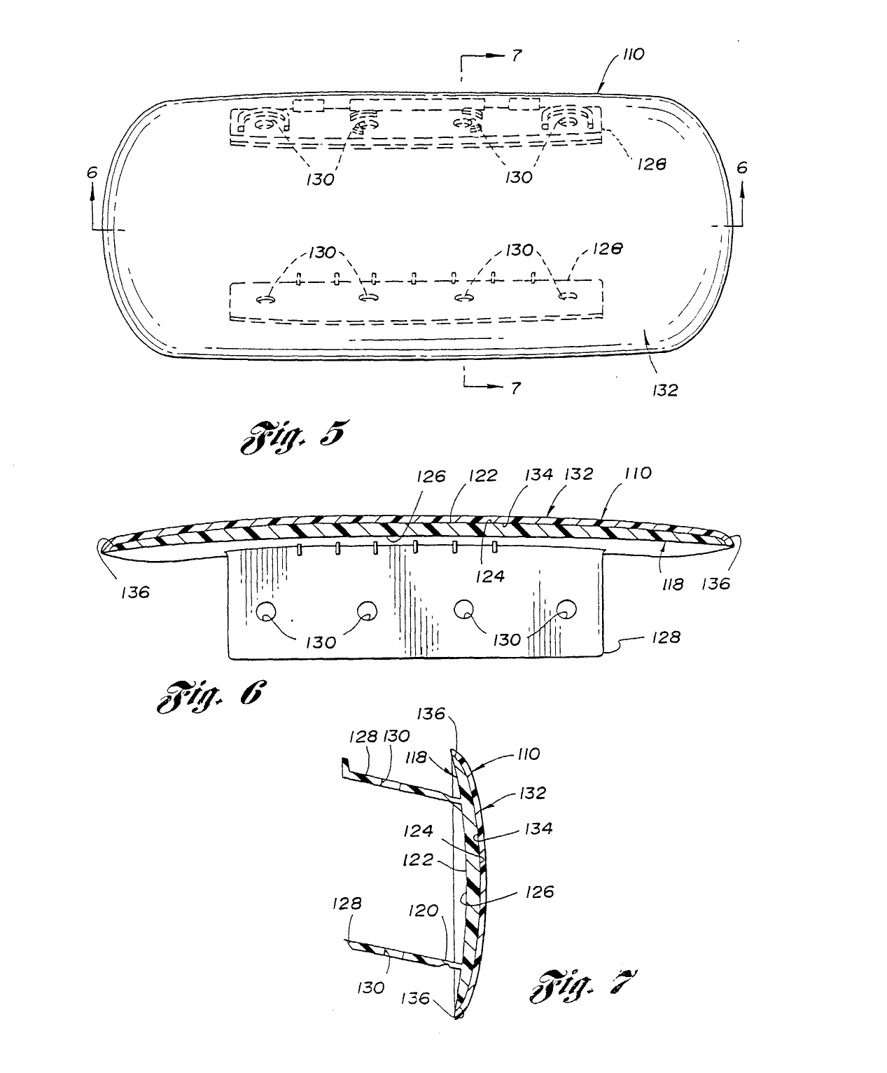

Referring now to the drawing figures, there is illustrated in FIG. 1 an environmental view showing first and second embodiments of an air bag cover, generally indicated at 10 and 110, respectively, constructed in accordance with the present invention. The air bag cover 10 preferably is installed over an inflatable air bag system, a portion of which is shown at 12 in FIG. 4, mounted at the end of a steering wheel post (not shown) having a steering wheel 14. The occupant restraint air bag system is typically mounted at the interior end of the steering wheel post within the steering wheel 14 so that the air bag may deploy between the vehicle driver and the steering wheel post to prevent injury during an accident or other period of sudden deceleration.

The air bag cover 110 is typically mounted in a surface 112 of a dashboard or instrument panel, generally indicated at 114, located in underlying relationship to a sloped front windshield 116.

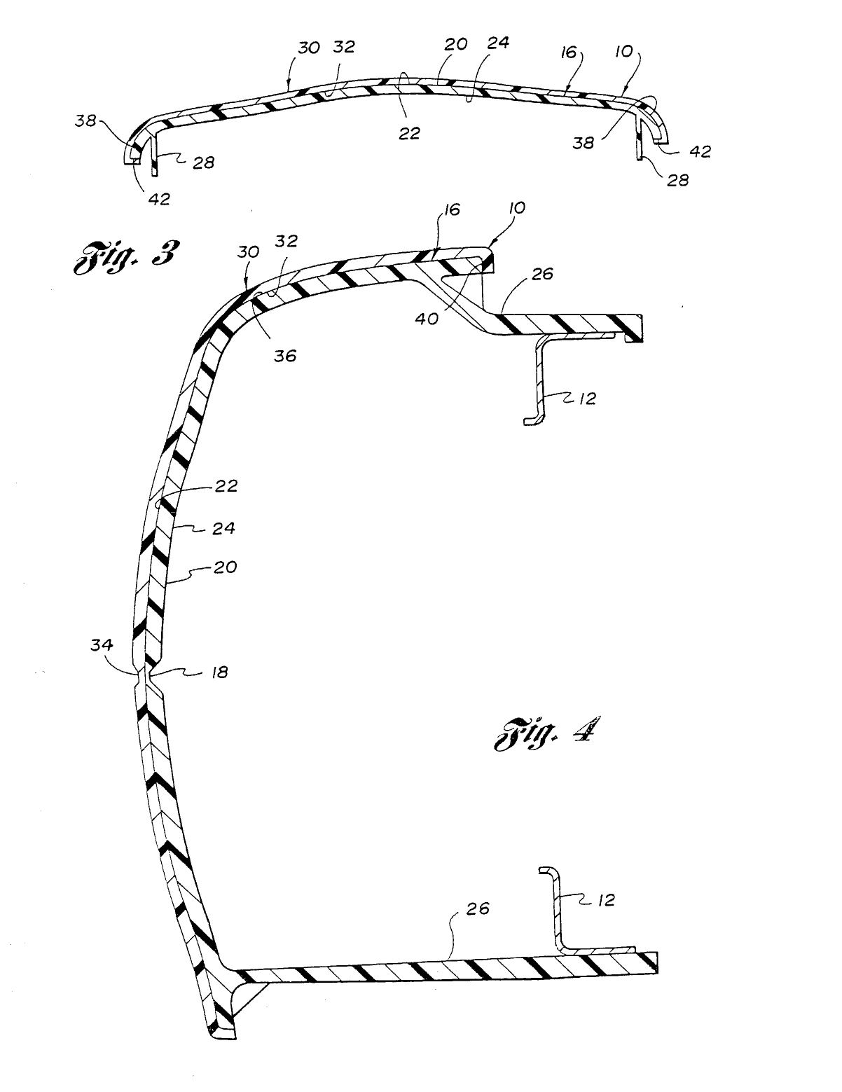

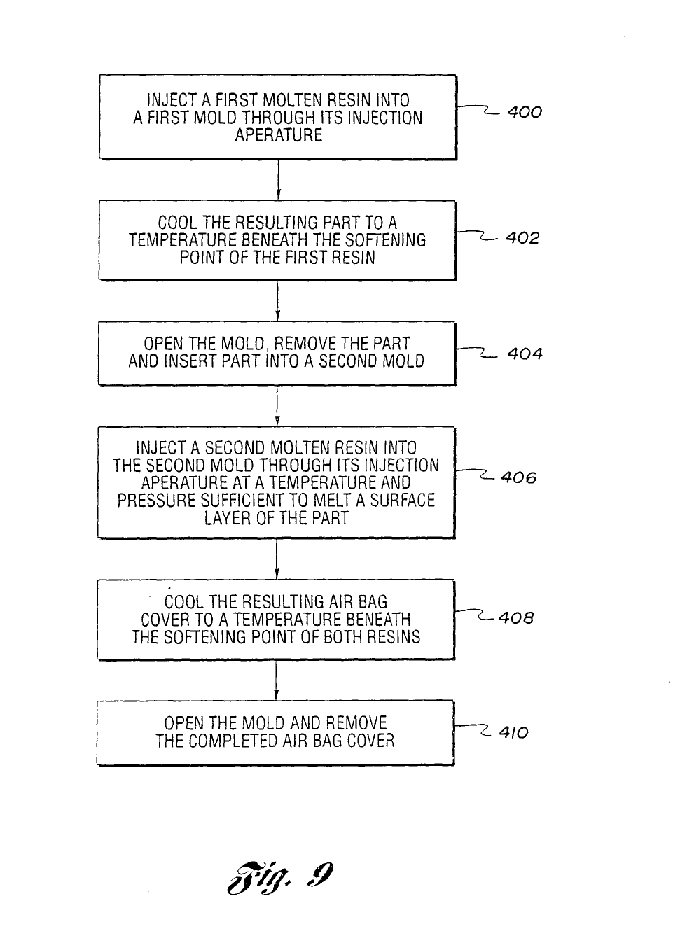

Referring now to FIGS. 2-4, there is illustrated in detail the first embodiment of the air bag cover 10 constructed in accordance with the present invention. The air bag cover 10 includes a one-piece thermoplastic elastomeric body, generally indicated at 16, which is preferably injection molded in a first mold (FIG. 8) and has a predetermined tear seam design as indicated at 18. The thermoplastic elastomeric body 16 includes a front panel 20 having front contact and back surfaces 22 and 24, respectively, and side panels 26 and 28 which extend from the back surface 24 of the front panel 20 and which are adapted to secure the air bag cover 10 over an inflatable air bag system by incorporating holes therein to enable fastening members such as screws to secure the air bag cover 10 to a canister or mounting plate 12 of the air bag system.

The air bag cover 10 also includes a one-piece outer layer, generally indicated at 30, injection molded in a second mold from a thermoplastic material compatible with the thermoplastic elastomer of the body 20 so that a bottom contact surface 32 of the outer layer 30 bonds with the front contact surface 22 of the front panel 20 by diffusion between the surfaces 22 and 32 thereof in a second mold (as illustrated in FIG. 8) to prevent the body 20 from separating from the outer layer 30 during use of the air bag cover 10.

Preferably, the plastic material of the outer layer 30 is relatively soft and the thermoplastic elastomer of the front panel 20 is relatively stiff. Also, preferably, the thermoplastic elastomer of the body 16 is TEO or polyester whereas the thermoplastic material of the outer layer is TES or vinyl, respectively. When the outer layer 30 is vinyl, no paint is required for the air bag cover 10 since the color of the vinyl can be matched to the color of the vehicle interior. Preferably, the TES is KRATON™, a rubber-based material available from Shell Oil Company. The durometer and elastic or flex modulus of the materials can vary depending on the desired stiffness of the cover. Typically, the durometer of the body 20 will be in the range of about 37 Shore D to 52 Shore D, while the flexural modulus will be in the range of about 30,000 to 70,000 psi. Also, typically, the durometer of the outer layer 30 will be in the range of about 35 Shore A to 55 Shore A.

As illustrated in FIG. 4, the outer layer 30 also has a predetermined tear seam design 34 formed therein which is coincident with the predetermined tear seam designed 18 formed in the front panel 20 to allow the air bag to exit the air bag cover 10 when deployed.

As illustrated in FIGS. 3 and 4, the front panel 20 has curved side contact surfaces 36 and 38 extending from the front surface 22 and wherein the contact surface 32 of the outer layer 30 is bonded with the contact surfaces 36 and 38 of the front panel 20 by diffusion between the surfaces.

Also, the contact surface 32 of the outer layer 30 is bonded with the contact surface 24 of the front panel 20 at edges 40 and 42 by diffusion between the surfaces 32 and 24.

Referring now to FIGS. 5-7, there is illustrated a second embodiment of the air bag cover 110 constructed in accordance with the present invention. The unitary composite air bag cover 110 also includes a one-piece thermoplastic elastomeric body, generally indicated at 118, which is injection molded in a second mold (FIG. 8) with a predetermined tear seam design 120 formed therein, as illustrated in FIG. 7. The body 118 also includes a panel 122 having front contact and back surfaces 124 and 126, respectively. The body 118 also includes side panels 128 which extend from the back surface 126 of the panel 122 and which are adapted to secure the air bag cover 110 over an inflatable air bag system (not shown) by being apertured at holes 130. The holes 130 are adapted to receive screws or other fasteners to secure the air bag cover 110 to a canister or mounting plate of its covered bag system.

The air bag cover 110 also includes a onepiece outer layer, generally indicated at 132, which is molded in a first mold (FIG. 8) from a thermoplastic material compatible with the thermoplastic elastomer of the body 118 so that a bottom contact surface 134 of the outer layer 132 bonds with the contact surface 124 of the front panel 122 by diffusion between the contact surfaces 124 and 134 thereof in the second mold (FIG. 8) to prevent the body 118 from separating from the outer layer 132 during use of the air bag cover 110.

Preferably, the plastic material of the outer layer 132 is relatively soft and the thermoplastic elastomer of the front panel 122 is relatively stiff. Preferably, the thermoplastic elastomer of the body 118 is TEO or polyester and the corresponding thermoplastic material of the outer layer 132 is TES or vinyl, respectively as in the case of the air bag cover 10.

As shown in FIG. 7, one of the side panels 128 of the body 118 has the predetermined tear seam 120 formed therein to allow the air bag to exit the air bag cover 110 when deployed.

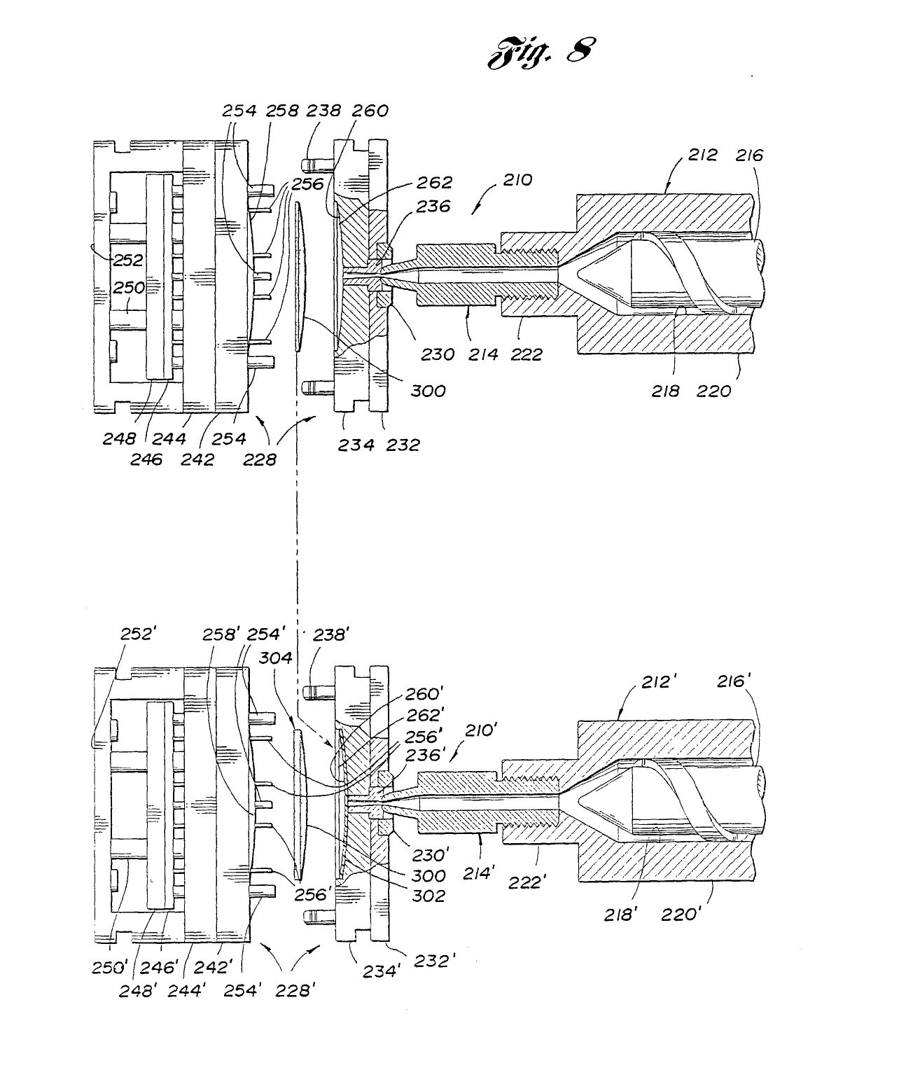

As illustrated in FIGS. 6 and 7, the panel 122 has curved side contact surface 136 extending from the front contact surface 124 and the contact surface 134 of the outer layer 132 is bonded with the contact surfaces 136 of the front panel 122 by diffusion between the contact surfaces 136 and 134.

Referring now to FIG. 8, there is illustrated a first conventional injection molding system, generally indicated at 210, and a second conventional injection molding system, generally indicated at 210′, for collectively making a unitary composite air bag cover (either 10 or 110) of the present invention. Only the first injection molding system 210 will be specifically described and not the second injection molding system 210′. However, it is to be understood that parts of the second injection molding system 210′ which have the same or similar function to the parts of the first injection molding system 210 have the same reference numeral except with a prime designation.

Briefly, the injection molding system 210 includes an injection molding machine, generally indicated at 212, having a nozzle, generally indicated at 214, for injecting predetermined amounts or shots of molten resin. The injection molding machine 212 includes a hydraulic screw ram 216 which is disposed in a bore 218 formed in a barrel 220 of the injection molding machine 212. The ram 216 plasticizes and advances resin towards the nozzle 214. Upon complete plasticization of the resin, the screw ram 216 is hydraulically advanced towards threaded portions 222 of the barrel 220 to inject molten plastic through the nozzle 214, as is well known in the art.

The system 210 also includes a mold or mold body generally indicated at 228. As illustrated in FIG. 8, the mold 220 comprises a two-plate mold body. One of the plates includes a locating ring 230 for locating the injection end of the nozzle 214. The locating ring 230 is mounted on a clamp plate 232 which, in turn, is fixably connected to a cavity retainer plate or cavity plate 234. A sprue bushing 236 is disposed within the locating ring 230 and is supported by the clamp plate 232. Leader pins 238 on the cavity plate 234 provide the male half of the male-female connection of the first plate with the second plate of the two-plate mold 228. In particular, the second plate includes leader pin bushings (not shown) which slidably receive and retain the leader pins therein in the closed position of the mold 228. The leader pin bushings are retained within a core retainer plate 242. The core retainer plate 242 is fixably connected to a support plate 244 which in turn is connected to an injector retainer plate 246. The injector retainer plate 246 is connected to an injector plate 248 which, in turn, is supported by support pillars 250. Support plate 244 is also fixably connected to the ends of a U-shaped ejector housing 252 to which the support pillars 250 are also connected. The plate 246 supports a plurality of return pins 254 and ejector pins 256 which extend toward the plate 234 and through the plates 242 and 244. The ejector pins 256 are provided for ejecting particular injection molded part(s) from the mold 228.

Opposing surfaces of male and female mold parts 258 and 260 respectively define a mold cavity 262. The mold part 258 is supported on the plate 242 and the mold part 260 is supported on the cavity retainer plate 234.

As illustrated in FIG. 8, there is illustrated how a one-piece thermoplastic elastomer body 300 is first molded in the first injection molding system 210 then placed in the mold cavity 262′. Thereafter the one-piece outer layer 302 is molded in the second plastic injection molded system 210′ thereover to form the completed unitary composite air bag cover, generally indicated at 304, when the one-piece outer layer 302 overlies the body 300.

Referring now to FIG. 9, there is illustrated the various process steps of the method of the present invention.

At block 400, initially the first molten plastic is injected into the first mold through its injection nozzle 214.

At block 402, the resulting part 300 is cooled to a temperature beneath the softening point of the first plastic.

At block 404, the first mold is open and the part 300 is removed and inserted into the second mold.

At block 406, the second molten plastic is injected into the second mold through its injection nozzle 214′ at a temperature and pressure sufficient to melt a surface laver of the part 300.

At block 408, the resulting air bag cover 304 is cooled to a temperature beneath the softening point of both plastics.

Finally, at block 410, the mold is open and the completed air bag cover 304 is removed.

In this way, a one-piece TEO or polyester-type plastic substrate, which includes a predetermined tear seam design to allow the air bag to exit the cover when deployed is molded. Once the TEO or polyester substrate has been molded, this substrate is then inserted into the “skin” (i.e. outer layer) mold core side. The skin mold then closes with the substrate firmly positioned, then a softer compatible plastic such as TES (with respect to the TEO) or a vinyl material (with respect to the polyester) is then molded over the substrate forming the final tear seam and cover design. After this procedure, the substrate and skin have been bonded through the thermoplastic injection process to produce a two-shot driver air bag cover.

With respect to the passenger side air bag cover 110 preferably the TES or vinyl-type plastic skin (outer layer), which is used to create an acceptable appearance (i.e. Class A) surface of the air bag cover, is completed first. Once the TES or vinyl skin has been molded, this skin is inserted into the core mold. The core mold then closes with the skin strategically held, then a harder compatible plastic such as TEO (with respect to TES) or polyester (with respect to vinyl) is then molded behind the skin forming the final tear seam and/or design. After this procedure, the skin and substrate have been bonded through the thermoplastic injection process to produce a two-shot passenger air bag cover.

The body 16 or 18 of the air bag cover 10 or 110, respectively, may also be formed from polypropylene, TPO (thermoplastic olefin), or TPU (thermoplastic urethane). The corresponding outer layer 30 or 132 must be compatible with the plastic of the body 16 or 118 so that diffusion between contact surfaces occurs.

The unique features of the driver's side air bag and the passenger's side air bag cover are:

i) a soft outer shell to increase customer's satisfaction;

ii) a stiff inner material to support the air bag cover during deployment (and during horn actuation with respect to the driver's side air bag cover);

iii) independent molding of separate components to relieve press downtime.

iv) utilization of smaller injection molding machines;

v) with respect to the air bag door, a more consistent feel of the instrument panel to the air bag cover; and

vi) with respect to the vinyl, no painting is required.

While the best mode for carrying out the invention has been described in detail, those familiar with the art to which this invention relates will recognize various alternative designs and embodiments for practicing the invention as defined by the following claims.

What is claimed is:

1. A unitary composite air bag cover comprising:
a one-piece, thermoplastic elastomeric body injection molded in a first mold with a predetermined tear seam design formed therein and including a front panel having front and back contact surfaces and side panels extending from the back surface of the front panel and adapted to secure the air bag cover over an inflatable air bag system; and
a one-piece outer layer injection molded in a second mold from a thermoplastic material compatible with the thermoplastic elastomer of the body so that a bottom contact surface of the outer layer bonds with the front contact surface of the front panel by diffusion between the contact surfaces thereof in one of the first and second molds to prevent the body from separating from the outer layer during use of the air bag cover.

2. The air bag cover of claim 1 wherein the plastic material of the outer layer is relatively soft and the thermoplastic elastomer of the front panel is relatively stiff.

3. The air bag cover of claim 2 wherein the thermoplastic elastomer of the body is TEO.

4. The air bag cover of claim 2 wherein the thermoplastic material of the outer layer is TES.

5. The air bag cover of claim 2 wherein the thermoplastic elastomer of the body is polyester.

6. The air bag cover of claim 2 wherein the thermoplastic material of the outer layer is vinyl.

7. The air bag cover of claim 1 wherein the front panel has the predetermined tear seam design formed therein to allow an air bag to exit the air bag cover when deployed.

8. The air bag cover of claim 7 wherein the outer layer also has a predetermined tear seam design formed therein and coincident with the predetermined tear seam design formed in the front panel to allow the air bag to exit the air bag cover when deployed.

9. The air bag cover of claim 1 wherein one of the side panels has the predetermined tear seam design formed therein to allow an air bag to exit the air bag cover when deployed.

10. The air bag cover of claim 1 wherein the front panel has curved side contact surfaces extending from the front contact surface and wherein the bottom contact surface of the outer layer is bonded with the side contact surfaces of the front panel by diffusion between the contact surfaces.

11. The air bag cover of claim 10 wherein the bottom contact surface of the outer layer is bonded with a back contact surface of the front panel by diffusion between the contact surfaces.

12. A unitary composite air bag cover consisting essentially of:
a thermoplastic elastomeric body injection molded in a first mold with a predetermined tear seam design formed therein and having an outer contact surface; and
a thermoplastic outer layer injection molded in a second mold and having an inner contact surface bonded to the outer contact surface of the body, the outer layer being bonded with the elastomeric body by diffusion between the contact surfaces thereof in one of the first and second molds to form the air bag cover and to prevent the outer layer from separating from the body during use of the air bag cover.

13. The air bag cover of claim 12 wherein the body is molded from a material selected from the group consisting of polyester and TEO and wherein the outer layer is molded from a material compatible with the material selected for the body so that the outer layer bonds by diffusion with the body.

14. A unitary composite air bag cover consisting essentially of:
a relatively rigid thermoplastic elastomeric body injection molded in a first mold with a predetermined tear seam design formed therein and having an outer contact surface; and
a relatively soft thermoplastic outer layer injection molded in a second mold and having an inner contact surface bonded to the outer contact surface of the body, the outer layer being bonded with the plastic body by diffusion in one of the first and second molds to form the air bag cover and to prevent the outer layer from separating from the bonded body during use of the air bag cover.

15. The air bag cover of claim 14 wherein the outer layer is molded from a material selected from the group consisting of TES and vinyl and wherein the body is molded from a material compatible with the material selected for the outer layer so that the outer layer bonds by diffusion with the body.

16. The air bag cover of claim 1 or claim 12 or claim 14 wherein the elastomeric body has a durometer in the range of about 37 Shore D to 52 Shore D and a flexural modulus in the range of about 30,000 to 70,000 psi.

17. The air bag cover of claim 16 wherein the outer layer has a durometer in the range of about 35 Shore A to 55 Shore A.

18. The method of making a unitary composite air bag cover for an inflatable air bag system, the method comprising the steps of:
injecting a first molten plastic into a mold cavity of a first mold having a shape defining a first part of the air bag cover;
permitting the resulting first part to cool to a temperature beneath the softening point of the first plastic;
removing the first part from the first mold;
inserting the first part into a mold cavity of a second mold having a shape defining the entire air bag cover;
injecting a second molten plastic into the mold cavity of the second mold at a temperature and pressure sufficient to melt a surface layer of the first part;
permitting the resulting air bag cover to cool to a temperature beneath the softening point of both plastics so that a molecular concentration gradient is formed at an interface between the first and second resins to bond the first and second plastics by diffusion; and
removing the completed air bag cover from the second mold.

19. The method claimed in claim 18 wherein the first molten plastic is a relatively rigid thermoplastic elastomer which forms a one-piece body having a predetermined tear seam design formed therein in the first mold and the second molten plastic is a relatively soft thermoplastic which forms a one-piece outer layer having a contact surface bonded to an outer contact surface of the body.

20. The method claimed in claim 19 wherein the body includes a front panel having the predetermined tear seam design formed therein.

21. The method claimed in claim 20 wherein the outer layer also has a predetermined tear seam design formed therein and coincident with the predetermined tear seam design formed in the front panel.

22. The method claimed in claim 19 wherein the body includes side panels adapted to secure the air bag cover over an inflatable air bag system and wherein one of the side panels has the predetermined tear seam design formed therein to allow an air bag to exit the air bag cover when deployed.
